(19) United States
(12) Patent Application Publication
(10) Pub. No.: US 2003/0237016 A1
(43) Pub. Date: Dec. 25, 2003

(54) System and apparatus for accelerating content delivery throughout networks

(76) Inventors: Scott C. Johnson, Round Rock, TX (US); Richard Beale, Austin, TX (US); Edward E. Olkkola, Austin, TX (US)

Correspondence Address: William W. Enders, O'KEEFE, EGAN & PETERMAN, Building C, Suite 200, 1101 Capital of Texas Highway South, Austin, TX, 78746, US

(21) Appl. No.: 09/797,199

(22) Filed: Mar. 1, 2001

Related U.S. Application Data
(60) Provisional application No. 60/187,211, filed on Mar. 3, 2000.

(51) Int. Cl. H02H 3/05

(52) U.S. Cl. 714/4

(57) ABSTRACT

The present invention provides a content router for delivering content throughout networks. The content router preferably includes a packet switching component, at least a first network component coupled to the packet switching component and a storage component coupled to the packet switching component. The packet switching component, the first network component and the storage component preferably cooperate to create an accelerated data path operable to deliver static content from one or more storage devices coupled to the content router to one or more clients coupled to a network.

This application claims priority from U.S. Provisional Patent Application Serial No. 60/187,211, filed Mar. 3, 2000, which is entitled “SYSTEM AND APPARATUS FOR INCREASING FILE SERVER BANDWIDTH,” the disclosure of which is being incorporated herein by reference.

### TECHNICAL FIELD

The present invention relates generally to content distribution and, more particularly, to routing content throughout networks.

### BACKGROUND

Web servers today are typically implemented as applications running on general purpose computing machines, usually expensive server-class computers. Such servers are generally burdened with handling the TCP/IP protocol, wireless protocol, the protocol for supported Web services such as HTTP and FTP, the file system, the block storage protocol used (e.g., SCSI, Fibre Channel, etc.), in addition to the operating system, and any other applications that may be running on the server. Cutting edge servers of today generally cannot deliver more than a few hundred megabits/second of content from storage to the network. The limitation in ability to rapidly deliver content from storage to a network through a server is a major problem facing the Internet and other networks today.

A variety of solutions currently exist for improving content delivery performance of traditional servers when employed as Web servers. Typically, and as illustrated in FIG. 1, these solutions use brute force. Examples of such brute force techniques include using faster processors, using more processors, i.e., multiple servers running in parallel, as well as using multiple PCI (peripheral component interconnect) bridges. Generally, each of these solutions fails to yield dramatic performance benefits at reasonable prices.

Alternatively, more elegant attempts to improve Web server performance have been made. However, these more elegant solutions generally employ proprietary operating systems which have been optimized for Web server tasks thereby making these more elegant solutions expensive and significantly limited by their underlying system architecture. Therefore, it may be concluded that the traditional servers and server architecture generally do not scale well in terms of content delivery.

In other areas, so called content accelerators have been designed which serve to replicate information and place it in convenient locations. Such content accelerators have also been called caching appliances. Manufacturers such as Cacheflow, Inktomi and Akamai produce such computing systems. As with similar solutions, content accelerators of this form can be expensive as well as generally limited as to the purpose they serve and functions they may perform.

In the world of the Internet, most service providers are interested in accommodating some number of ‘hits’ per minute. Accommodating some number of ‘hits’ translates generally into forming a corresponding number of TCP/IP connections and downloading at least one file via HTTP or FTP. Where traditional architectures are limited in their ability to handle increasing numbers of TCP/IP connections due to the software overhead involved in handling each session's state information, the service providers must generally calculate the number of ‘hits’ per minute that a single server is capable of handling, and then calculate the number of servers generally required to be running in parallel to handle a projected, aggregate load. Such connection limitations and disadvantages may be experienced in both wireline and wireless content serving.

This approach, while generally the only current solution to this problem, is fraught with disadvantages. For example, each additional server is typically relatively expensive, and generally presents an added management burden. Additionally, it is generally required that each server be connected to a load-balancing switch such that the incoming ‘hits’ may be distributed to all servers, further increasing costs.

The majority of the traffic generated from web hosting sites may be characterized as asymmetric, favoring movement from web servers to clients, and involving the transfer of static content. Approximately 70% of HTTP requests for data are for static content. FTP, the primary protocol used for file transfers ranging from MP3 files to software upgrades, is also responsible for transferring large volumes of static content. In addition to file downloads, newer protocols exist which have been designed to download ‘streams’ of static content such as video.

### SUMMARY OF THE INVENTION

A content delivery solution which does not posses the drawbacks experienced with traditional server farms involves employing a content router which may be used to offload storage reads from a host server's CPU (central processing unit) and I/O sub-system (Input/Output). Such a configuration enables virtually unlimited bandwidth scalability without additional CPU processors. In essence, the content router serves, at least in part, as a uni-directional content transport network appliance that accesses content from storage and routes it to requesting IP (Internet Protocol) addresses over a network. When deployed in conjunction with a conventional server responsible for storage writes, network management, and system administration, the flexibility of the general-purpose computer is maintained while the reliability of a network appliance to access static content is leveraged. Applications that may benefit from such a content router include the aforementioned file downloading, static HTTP content serving and streaming media, as well as web caching and other applications with intensive read operations.

Accordingly, the present invention provides a system for rapidly delivering large volumes of content from storage. The system preferably includes at least one content router having at least one network processor, memory operably coupled to the at least one network processor and at least one routing switch operably coupled to the network processor. In addition, the content router preferably includes a LAN interface operably coupled to the routing switch that is preferably operable to communicate with a local area network, a WAN interface operably coupled to the routing switch that is preferably operable to communicate with a wide area network and a SAN (storage area network) interface operably coupled to the routing switch that is preferably operable to communicate with a SAN. A program of instructions storable in the memory and executable in the processor is also included and is preferably operable to interrogate packets received through the WAN interface and to instruct the routing switch to switch the packets between the LAN, WAN and SAN interfaces based upon the results of the interrogation. At least one storage device coupled to the SAN interface may also be included in the system.

The present invention also provides a content router having a packet switching component, a first network component preferably coupled to the packet switching component and a storage component preferably coupled to the packet switching component. In one embodiment, the packet switching component, the first network component and the storage component cooperate to create an accelerated data path. The accelerated data path is preferably operable to deliver static content from one or more storage devices preferably coupled to the storage component to one or more clients preferably coupled to the first network component.

The present invention further provides a content router including at least one power supply and a motherboard preferably coupled to the power supply. The motherboard preferably includes at least one processor and memory preferably coupled to the processor. A rapidstack printed circuit board may also be provided and preferably coupled to the motherboard. In one embodiment, the rapidstack printed circuit board preferably includes at least one network processor, memory operably coupled to the network processor, a routing switch operably coupled to the network processor, a storage area network transceiver operably coupled to the routing switch and a first network transceiver operably coupled to the routing switch. The rapidstack printed circuit board is preferably operable to read the packet headers of network traffic received from one or more clients operably coupled to the first network transceiver and to process those packets containing requests for content accessible via the storage area network transceiver.

In a further embodiment, the present invention provides a system for delivering content throughout networks. The system preferably includes at least one server operably coupled to a local area network, at least one storage device operably coupled to a storage area network and at least one network appliance operably coupled to the local are network, the storage area network and a wide area network. In such an embodiment, the network appliance may interrogate network traffic received from the wide area network, process the network traffic requesting static content available from the storage device and switch network traffic not processed to the server via the local area network for validation.

The present invention provides technical advantages of an inherently secure read-only inter-networking architecture that generally guarantees system and content integrity as well as security.

A further technical advantage provided by the present invention includes content router management software which preferably runs coherently on all content routers in a cluster to dynamically balance demand loading, automatically detect hot-spot content demand and provide bandwidth allocation such that peak performance levels may be maintained.

Additional technical advantages provided by the present invention include the automatic discovery of new content routers added to a cluster and automatic configuration of the new content routers with parameters and storage content for content routers with the highest demand history.

The present invention further provides technical advantages of autonomous content streaming, infinite up-scaling of download throughput bandwidth and low-overhead system administration that scales logarithmically with throughput bandwidth as well as seamlessly integrating with standard network and system management software packages.

Another technical advantage provided by the present invention is the capability to efficiently handle a large number of simultaneous TCP/IP (Transmission Control Protocol/Internet Protocol) sessions.

The present invention provides high capacity relative to present TCP/IP connection setup and accelerates the delivery of static content from storage to a network. Benefits that may be realized by both the industry and customers who deploy the present invention, in such areas such as high volume Web Sites, include increased bandwidth by increasing performance throughput, deployment of fewer traditional servers, replacement of expensive server clusters with a less expensive, higher performing content router and offloading of processing from servers which may result in making available more processing capacity in those servers.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a schematic diagram depicting one example of a presently available server farm;

FIG. 2 is a schematic diagram depicting a content delivery system incorporating teachings of the present invention for serving content;

FIG. 3 is a schematic diagram depicting preferred data flows through components in one embodiment of a content router incorporating teachings of the present invention;

FIG. 4 is a schematic diagram depicting a high-level view of hardware components preferably included in one embodiment of a content router incorporating teachings of the present invention;

FIG. 5 is a schematic diagram depicting a more detailed view of a rapidstack printed circuit board preferably included in one embodiment of a content router incorporating teachings of the present invention;

FIG. 6 is a schematic diagram depicting a high level view of a software system incorporating teachings of the present invention;

FIG. 7 is a schematic diagram depicting selected components of the rapidstack software subsystem illustrated in FIG. 6 according to teachings of the present invention;

FIG. 8 is a schematic diagram depicting preferred components of the host processor software subsystem illustrated in FIG. 6 according to teachings of the present invention;

FIG. 9 is a schematic diagram depicting one embodiment of a content router cluster according to teachings of the present invention;

FIG. 10 is a schematic diagram depicting one embodiment of a system implementing a content router cluster according to teachings of the present invention; and

FIG. 11 is a schematic diagram depicting one embodiment of a high access network according to teachings of the present invention.

### DETAILED DESCRIPTION

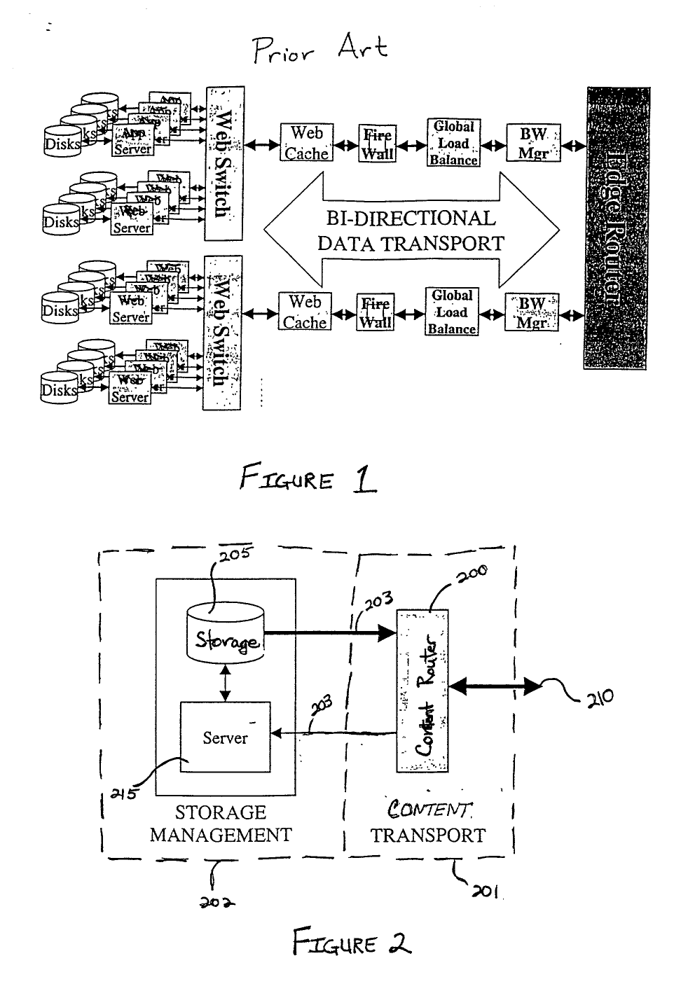

Preferred embodiments of the present invention and its advantages are best understood by referring to the FIGS. 1 through 11 of the drawings, like numerals being used for like and corresponding parts of the various drawings. In particular, the present invention is designed to dramatically increase the capacity and throughput of servers coupled to the Internet and other networks. Capacity may be measured in terms of the number of files that may be partially cached, the number of TCP/IP connections per second as well as the number of concurrent TCP/IP connections that may be maintained. Throughput is preferably measured in sustained data rates passed through the present invention and may be measured in bits per second.

A content router of the present invention accomplishes its goal of dramatically increasing capacity and throughput generally by focusing on the delivery of static content over a network while achieving sustained throughput rates that approach one gigabit per second, the achievement of 20,000 TCP/IP connections per second and achievement of 30,000 concurrent TCP/IP connections.

As illustrated in FIG. 2, one method for accelerating the transport of data from storage 205 to networks 210 is to separate the content transport functionality 201 from the storage/file system management functionality 202. Such a separation of storage management 202 and content transport functionality 201 enables fast, streamlined access to storage 205 from networks 210.

Content router 200 preferably includes a plurality of accelerated data paths 203 that interface between storage 205 and network 210 as well as manage the transport of content from storage 205 to network 210. Content routers 200 preferably terminate networks 210 via standard Gigabit Ethernet and are preferably operable to sustain one (1) Gbps (Gigabit per second) downstream throughput using high speed interfaces to storage 205 such as SCSI Ultra160/m (Small Computer Systems Interface), FC-AL (Fibre Channel-Arbitrated Loop) as well as other high speed storage 205 interfaces.

Preferably included in content router 200 are a high speed network access component, a high speed storage 205 access component, a server 215 access component, a content switching component (between high speed storage 205 access and server 215 access), and a systems management component. As such, one element that forms the basis for the operability of content router 200 is the ability to stream content from storage 205 to network 210. Content router 200 preferably attaches directly to the Internet (LAN/WAN), i.e., network 210, on one side, and directly to storage 205 via one or more accelerated data paths 203 on the other side. In addition, content router 200 preferably includes the ability to coordinate content management with server 215.

A plurality of physical interfaces are preferably included on content router 200. Content router 200 preferably supports physical interfaces to storage 205, a Wide Area Network (WAN) 210 (Internet) as well as a content router cluster/server cluster, typically via a LAN (local area network). In different embodiments, either wireline or wireless networks may be employed.

Scalability of content router 200 may be achieved by clustering two or more content routers 200. Clustering, in accordance with teachings of the present invention, generally results in increased performance and capacity. Content router 200 is preferably able to scale by making tradeoffs between the number of TCP/IP connections supported and throughput per TCP/IP connection provided. Content router 200 preferably provides consistent, sustained overall throughput. Content router 200 may also scale from many slower TCP/IP connections to fewer high-speed TCP/IP connections.

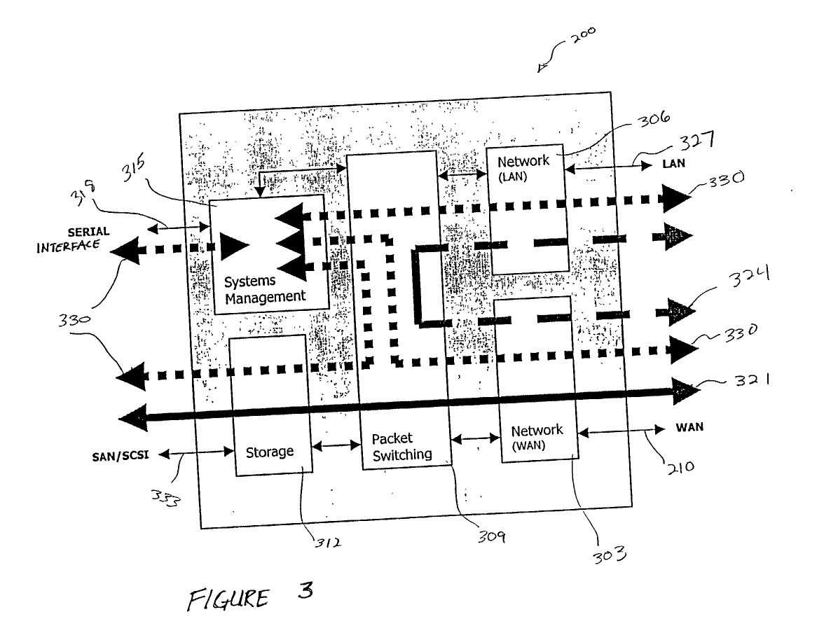

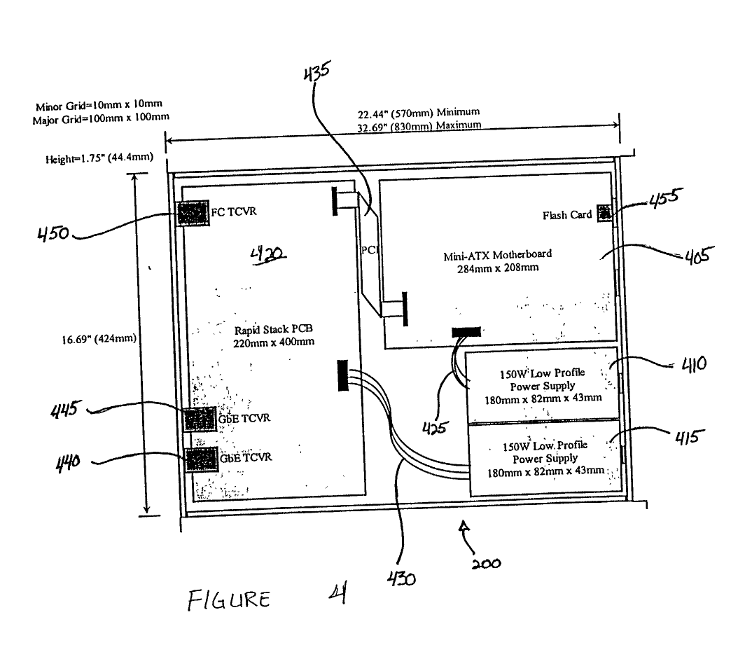

To facilitate an understanding of the present invention, it may be helpful to take a view inside. Referring now to FIG. 3, a representation of one embodiment of the components of content router 200 is illustrated. The first such component is WAN network component 303. WAN network component 303 preferably provides connectivity to a wide area network 210 such as the Internet. The network connectivity provided by WAN network component 303 preferably allows client and host computers coupled elsewhere on network 210 to communicate with content router 200. WAN network component 303 preferably supports a Gigabit Ethernet over fiber interface as well as a Gigabit Ethernet over copper interface. However, other network interfaces, such as wireless, may be supported by WAN network component 303.

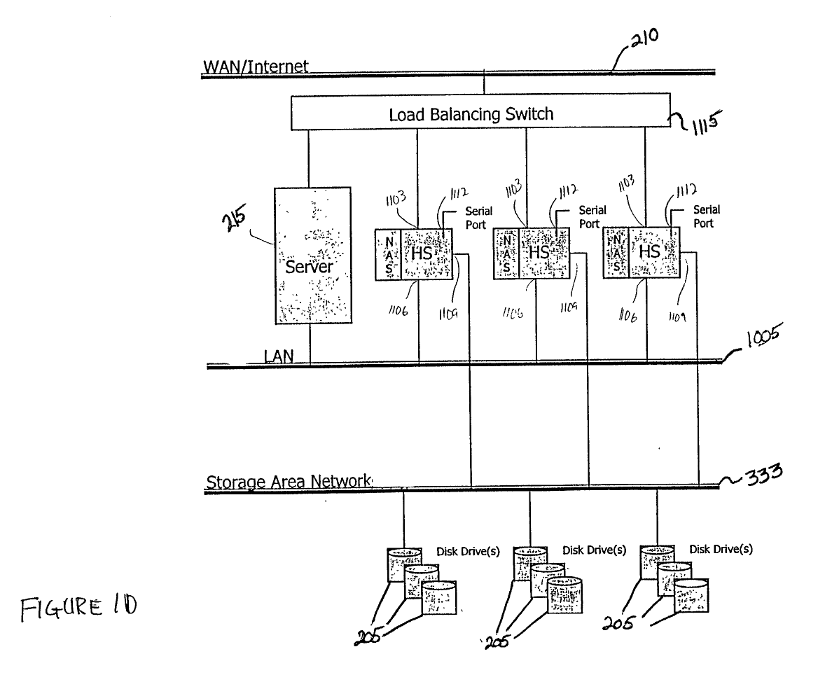

LAN network component 306 is a further component of content router 200. LAN network component 306 preferably provides connectivity to additional content routers 200 coupled in a cluster as well as connectivity to one or more servers 215, as illustrated in FIGS. 9-11. As such, each content router 200 may connect to a cluster of content routers 200 such that the flow of monitoring and control functions related to fault tolerance, load balancing, and systems management, etc., may be facilitated. By employing server 215 to manage static content on locally attached storage 205, enabling content router 200 to transmit monitoring and control information such that synchronization of read/write access to storage 205 is facilitated may be required and supported by LAN network component 306.

LAN network component 306 preferably supports a plurality of physical interfaces. Examples of such interfaces include, but are not limited to, Gigabit Ethernet over Fiber and Gigabit Ethernet over copper. Support for Infiniband may also be included in LAN network component 306 of content router 200.

Packet switching component 309 is another component of content router 200 as illustrated in FIG. 3. Packet switching component 309 is preferably configured to make decisions regarding the routing of packets between the various components of content router 200.

Storage component 312 is yet another component of the present invention as illustrated in FIG. 3. Storage component 312 is preferably operable to provide connectivity to storage 205 on a storage area network (SAN) 333. Storage component 312 is preferably operable to provide content obtained from storage 205 to network 210. Examples of physical interfaces to storage may include, but are not limited to, Fibre Channel Storage Area Networks and SCSI.

Systems management component 315 is a further component of content router 200 as illustrated in FIG. 3. Systems management component 315 preferably performs functions related to the management of content router 200. Systems management component 315 may also provide connectivity to a serial port 318 preferably included on content router 200.

The preferred flow of content packets through the components of content router 200 may be indicated by the arrows illustrated in FIG. 3. Arrow 321 generally indicates the streaming of static content from storage 205 to network 210. Packets flowing along this path may include, but are not limited to, TCP/IP connection set up and tear down packets as well as requests and responses for static content.

Arrow 324 generally indicates the flow of packets that may be switched between WAN 210 and LAN 327. These packets may be switched between content router 200 and one or more servers 215. Packets flowing along this path may include, but are not limited to, TCP/IP connection set up and tear down packets for unsupported application protocols as well as other packets relating to unsupported application protocols.

Arrows 330 indicate the preferred flow of packets in to and out of systems management component 315. These packets may include, but are not limited to, SNMP (simple network management protocol), HTTP (hypertext transfer protocol) and other protocol packets relating to systems management functions on both LAN 327 and WAN 210, packets from one or more servers 215 on LAN 327 attempting to access storage 205, file I/O (Input/Output) packets switched between systems management 315 and storage 312 components as well as systems management control and information packets through the serial interface 318.

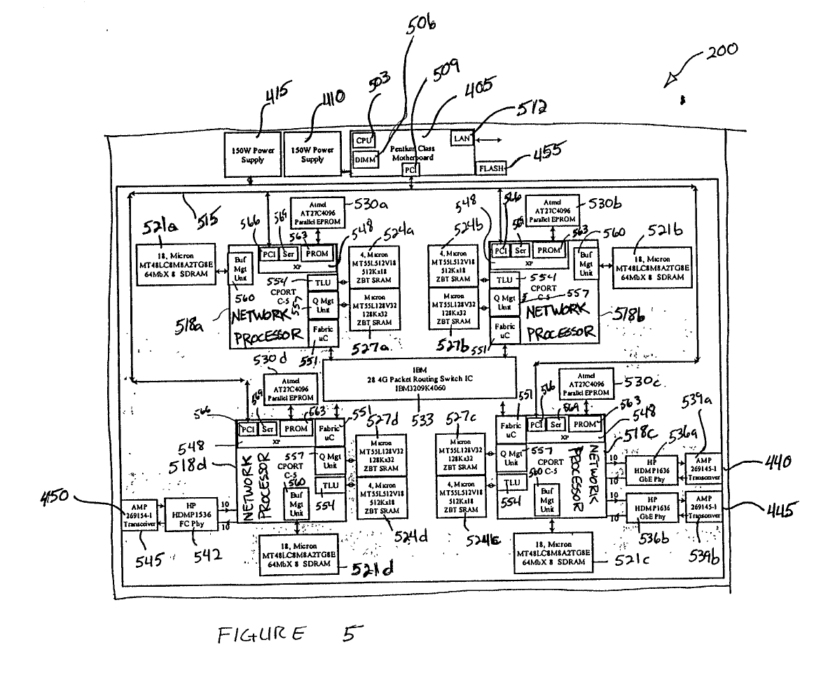

Referring now to FIG. 4, a schematic diagram depicting an internal view of content router 200 is shown. The functionality and operation of content router 200 may be implemented in part by hardware and in part by software. A preferred hardware implementation of content router preferably includes Pentium class motherboard 405, first 410 and second 415 power supplies as well as rapidstack printed circuit board (PCB) 420.

In a preferred embodiment, first power supply 410 is operably coupled to Pentium class motherboard 405 via electric cabling 425 and second power supply 415 is operably coupled to rapidstack PCB 420 via electric cabling 430. Rapidstack PCB 420 and Pentium class motherboard 405 may be preferably coupled via PCI (peripheral component interconnect) cable 435 although other coupling may be employed. Flash memory 455 is preferably included on Pentium class motherboard 405 to allow for software and firmware updates to be easily installed on content router 200.

Content router 200 is preferably operable to communicate with external devices via ports conventionally included on Pentium class motherboard 405 as well as by communication ports included on rapidstack PCB 420. Illustrated in FIG. 4, are examples of such communications ports. Specifically, FIG. 4 illustrates first 440 and second 445 Gigabit Ethernet transceivers and Fibre Channel transceiver 450. Depending upon the type of hardware employed in the remainder of a network system, rapidstack PCB 420 may couple to storage 205, server 215 as well as networks 327, 333 and 210 via any of communications ports 440, 445 and 450.

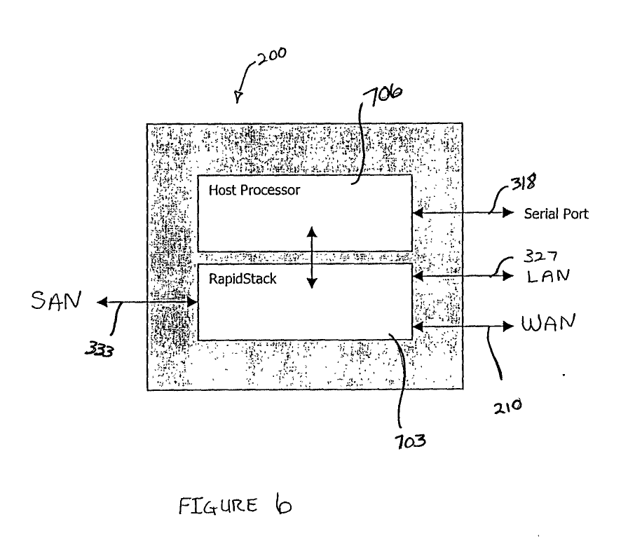

Referring now to FIG. 5, a more detailed view of the preferred internal hardware components of content router 200 is shown. Similar to that illustrated in FIG. 4, first power supply 410 is preferably coupled to Pentium class motherboard 405 and second power supply 415 is preferably coupled to rapidstack PCB 420.

In addition to FLASH memory 455, Pentium class motherboard 405 preferably includes central processing unit (CPU) 503, memory 506, PCI connector 509 and LAN transceiver 512. CPU 503 and memory 506 preferably enable Pentium class motherboard 405 to execute and store respectively, software operable to perform at least a portion of the preferred functions of content router 200. PCI connector 509 enables Pentium class motherboard 405 to be preferably coupled to rapidstack PCB 420 via a cabling such as PCI cabling 435 illustrated in FIG. 4. LAN transceiver 512 is preferably included on Pentium class motherboard 405 to allow content router 200 to communicate with other content routers 200 included in a cluster as well as to communicate with other components which may be coupled to LAN 327.

In the embodiment of rapidstack PCB 420 illustrated in FIG. 5, PCI bus 515 is preferably employed to operably couple the preferred components of rapidstack PCB 420. Among the preferred components illustrated in the preferred embodiment of FIG. 5, are network processors (NP) 518a-518d, SDRAM (synchronous dynamic random) modules 521a-521d such as the Micron MT48LC8M8A2TG8E, SRAM (static random access memory) modules 524a-524d and 527a-527d such as the Micron MT55L518V18 and MT55L128V32 respectively, EPROM (electronically programmable read-only memory) modules 530a-530d such as the ATMEL AT27C4096, packet routing switch integrated circuit (IC) 533 such as the IBM IBM3209K4060, first and second Gigabit Ethernet transceivers 440 and 445, transceivers 440 and 445 preferably including Gigabit Ethernet ICs 536a-536b such as the Hewlett Packard HDMP1636 and Gigabit Ethernet connectors 539a-539b such as the AMP261945-1 respectively, and Fibre Channel transceiver 450, Fibre Channel transceiver 450 preferably including Fibre Channel IC 542 such as the Hewlett Packard HDMP1536 and Fibre Channel connector 545 such as the AMP 269154-1. Other embodiments and configurations may be implemented in content router 200.

NPs 518a-518d, such as the C-Port C-5 digital communications processor manufactured by Motorola Corporation, preferably contain sub-components that are operable to interconnect the various components of rapidstack PCB 420. Accordingly, each NP 518a-518d preferably includes executive processor (XP) 548, fabric processor (FP) 551, table lookup unit (TLU) 554, queue management unit (QMU) 557 and buffer management unit (BMU) 560. XP 548 preferably further includes PROM (programmable read-only memory) 563, PCI connector 566 and serial connector 569.

XP 548 is generally responsible for managing NPs 518a-518d as well as coordinating the functions of NPs 518a-518d with any external processors such as CPU 503. FP 551 is generally responsible for scaling network processors 518a-518d with switching fabrics such as packet routing switch IC 533. TLU 554 is generally responsible for implementing table searches and updates and QMU 557 is generally responsible for integrating queue control and management. BMU 560 is generally responsible for providing fast, flexible memory management.

Network processors 518a-518d are preferably coupled to PCI bus 515 via PCI connector 566 of XP 548. Also preferably coupled to XP 548, via PROM 563, are EPROMs 530a-530d. A SRAM module 524a-524d is preferably coupled to a TLU 554 of each network processor 518a-518d. Similarly, a SRAM module 527a-527d is preferably coupled to a QMU 557 of each network processor 518a-518d and a SDRAM module 521a-521d is preferably coupled to a BMU 560 of each network processor 518a-518d. Packet routing switch IC 533 is preferably coupled to each network processor 518a-518d at the FC 551 of each network processor 518a-518d.

As illustrated in FIG. 5, Fibre Channel IC 542 is preferably coupled to network processor 518d on one side and preferably coupled to Fiber Channel connector 545 on another side. Such a configuration enables network processor 518d to communicate information out of Fiber channel transceiver 450 as well as receive information in to Fiber Channel transceiver 450. Similarly, Gigabit Ethernet transceivers 440 and 445 are illustrated preferably coupled to network processor 518c. As mentioned above, other configurations and component arrangements are considered within the scope of the present invention.

Referring now to FIG. 6, a schematic drawing illustrating one embodiment of a software architecture incorporating teachings of the present invention is depicted. Accordingly, the software architecture illustrated in FIG. 6 preferably consists of two subsystems, rapidstack subsystem 703 and host processor subsystem 706. As you will recall from FIG. 3 above, there are preferably four external interfaces included on content router 200. FIG. 6 illustrates that host processor subsystem 706 preferably communicates with serial port interface 318, while rapidstack subsystem 703 preferably communicates with WAN 210, LAN 327 and SAN 333.

The general purpose of rapidstack subsystem 703 is to generate responses to qualified client requests preferably at wire speed. Additionally, rapidstack subsystem 703 may also provide interfaces for a host operating system (OS) to send and receive data through. The components of rapidstack subsystem 703 are basic components of the software architecture. Rapidstack subsystem 703 may also serve additional functions according to teachings of the present invention. For example, rapidstack subsystem 703 may: provide an external interface to network 210; provide an external interface to LAN 327; provide an external interface to storage 205 through SAN 333; set up TCP/IP connections as such requests flow in from network 210; accept HTTP read requests and FTP Gets; switch HTTP read requests for dynamic data to a server 215 on LAN 327; switch local storage file writes from server 215 to host processor subsystem 706; accept redirected local storage file writes from host processor subsystem 706; perform caching of files from local storage 205 to cache memory; stream data from storage 205 to network 210 preferably at wire speed; handshake with host processor subsystem 706 to synchronize read/write access to storage 205; handshake with host processor subsystem 706 to maintain cache coherency; handshake with host processor subsystem 706 to maintain a current file system directory; as well as handshake with host processor subsystem 706 to provide data instrumentation to support systems management 315.

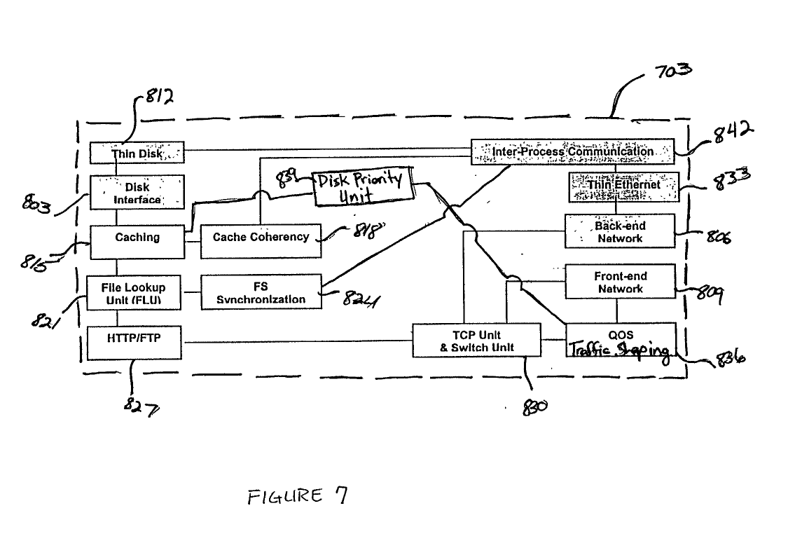

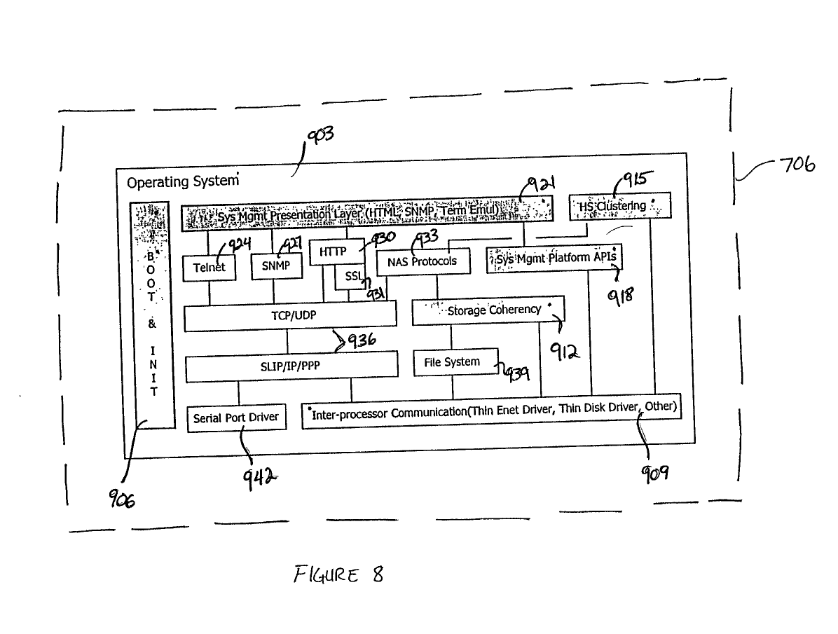

Referring now to FIG. 7, the preferred software modules of rapidstack subsystem 703 are depicted according to one embodiment of the present invention. Rapidstack subsystem 703 preferably includes modules: thin disk 812; disk interface 803; caching 815; cache coherency 818; file lookup unit (FLU) 821; file system synchronization 824; HTTP/FTP 827; TCP/IP & switch (TCP/SW) 830; thin Ethernet 833; back-end network 806; front-end network 809; traffic shaping 836; disk priority 839; and inter-process communication (IPC) 842.

Thin disk module 812 preferably enables communication between a host OS and storage 205. Thin disk module 812 preferably presents an interface that closely matches the interface for a disk controller and, as such, minimizes the specialization needed by the host OS and host OS disk controller device driver. On the host OS, the disk controller device driver is preferably written to communicate with thin disk module 812. Generally, all host OS storage 205 communication comes through thin disk module 812.

Requests from the host OS may be passed to disk interface module 803. Responses from disk interface module 803 intended for the host OS will preferably be passed to thin disk module 812. As such, the external interfaces for thin disk module 812 preferably include the inter processor communication (IPC) module 842 and disk interface module 803.

Disk interface module 803 preferably serves as the disk controller for rapidstack subsystem 703. As mentioned above, the physical interface to storage 205 is preferably Fibre Channel or SCSI, emphasizing high performance and low latency. Disk block requests may be received from caching module 815. Disk block requests are then preferably sent on to SAN 333 as a FC or SCSI command by disk interface module 803. When a disk block response is received by disk interface module 803, the disk block response is preferably sent to caching module 815. Disk block requests may also come from thin disk module 812. When the host OS makes a disk block request, it is generally received from thin disk module 812. This disk block request may then be sent on to SAN 333 as an FC or SCSI command again, by disk interface module 803. When a block response is received, it is preferably sent back to the host OS via thin disk module 812. External interfaces of disk interface module 803 preferably includes thin disk module 812 and caching module 815.

Caching module 815 generally provides an elastic buffer between the disk block requests received from FLU module 821 and disk interface module 803. Cache entries may be labeled with fully canonicalized filenames and their respective offsets in a file. Each cache entry is preferably a whole disk block. Caching module 815 generally receives disk block requests from FLU module 821. Caching module 815 preferably receives cache update messages from the host OS file system via cache coherency module 818. This is necessary so that when the host OS file system makes changes to one or more files in storage, caching module 815 will have a way to resynchronize rapidstack subsystem's 703 cache. Caching module 815 may also receive block requests from FLU module 821 and may also send block responses to FLU module 821. External interfaces of caching module 815 preferably include cache coherency module 818, FLU module 821 and disk interface module 803.

Cache coherency module 818 preferably keeps caching module 815 synchronized with the host OS file system. The host OS file system may send cache synchronization messages to cache coherency module 818, which may then be communicated to caching module 815. Whenever the host OS file system makes a change that affects a particular file, a message is preferably sent to cache coherency module 818 so that caching module 815 may ensure its cache is refreshed. Cache coherency module 818 may receive messages from the host OS that preferably allow caching module 815 to keep the disk block cache up to date. Commands may be passed to caching module 815 to allow invalid cache data to be refreshed. The external interfaces of cache coherency module 818 preferably include caching module 815 and IPC module 842.

File lookup unit (FLU) module 821 preferably translates file requests from HTTP/FTP module 827 into disk block requests. The translation is preferably highly optimized and may utilize a super-efficient translation table provided by the host OS file system. Updates to this table are generally received through file system synchronization module 824. It is preferable that FLU module 821 paces disk block requests based on connection bit rates. Table updates are preferably coordinated to allow uninterrupted rapidstack subsystem 703 activity and at the same time to allow file changes from the host OS to be processed. The external interfaces of FLU module 821 preferably include file system synchronization module 824, HTTP/FTP module 827 and caching module 815.

File system synchronization module 824 preferably receives messages from the host OS file system and keeps the translation table up to date. The translation table may be used by FLU module 821 to efficiently perform file request translations. The external interfaces of file system synchronization module 824 preferably include FLU module 821 and IPC module 842.

HTTP/FTP module 827 may receive HTTP/FTP messages from TCP/SW module 830 and translate those messages into file requests. The file requests may then be passed to FLU module 821. This module may also receive file responses from FLU module 821 and generate HTTP/FTP response messages that may be passed back to TCP/SW module 830. The external interfaces of HTTP/FTP module 827 preferably include TCP/SW module 830 and FLU module 821.

TCP/SW module 830 preferably receives incoming packets from front-end network module 809. Each packet is preferably analyzed to determine if it should be handled by rapidstack subsystem 703. If the packet is supposed to be handled by rapidstack subsystem 703, it may then be passed on to HTTP/FTP module 827. Otherwise, the packet is passed on to back-end network module 806. The external interfaces of TCP/SW module 830 preferably include traffic shaping module 836, front-end network module 809, back-end network module 806 and HTTP/FTP module 827.

Traffic shaping module 836 preferably shapes outgoing traffic. The purpose of traffic shaping is generally to make the most efficient use of rapidstack subsystem 703 bandwidth. Data is generally received from TCP/SW module 830. The data may then be sent to front-end network module 809 at a rate that may be based on QoS (quality of service) protocols as defined by the IETF (Internet Engineering Task Force) and may also be based on configuration settings provided through systems management. Traffic shaping module 836 may also communicate with caching module 815 to help prioritize disk block requests. This information may be communicated to disk priority module 839. The external interfaces of traffic shaping module 836 preferably include disk priority module 839, front-end network module 809 and TCP/SW module 830.

Front-end network module 809 preferably receives incoming requests from clients coupled to network 210. Each incoming packet is preferably pre-processed as deeply as possible with an emphasis on rapidstack subsystem 703 performance. The packet may then be sent to TCP/SW module 830. The external interfaces of front-end network module 809 preferably include traffic shaping module 836 and TCP/SW module 830.

Back-end network module 806 preferably receives incoming packets from TCP/SW module 830 and places those on to LAN 327 as Ethernet packets destined for server 215. Packet replies from server 215 are preferably pre-processed and passed on to TCP/SW module 830. Back-end network module 806 may also receive incoming file system requests that are destined for the host OS. These requests may be pre-processed and sent to thin Ethernet module 833. Replies coming from the host OS may be received from thin Ethernet module 833. The packets may be placed on to LAN 327 as Ethernet packets destined for server 215. The external interfaces of back-end network module 806 preferably include thin Ethernet module 833 and TCP/SW module 830.

Thin Ethernet module 833 preferably provides the interface for the host OS to send and receive packets on LAN 327. Thin Ethernet module 833 may look similar to a network interface cord device driver in order to minimize customization needed to the host OS device driver software. Incoming packets received from LAN 327 may be formatted and passed to the host OS. Outgoing packets received from the host OS may be sent to server 215 through LAN 327. The external interfaces of thin Ethernet module 833 preferably include IPC module 842 and back-end network module 806.

Inter-Process communication module 842 preferably provides a well-defined generic interface for all communications between the host OS and rapidstack subsystem 703. The method of communication is preferably hidden from other software modules. The preferred external interfaces of IPC module 842 include thin disk module 812, cache coherency module 818, thin Ethernet module 833 and the host OS.

Disk priority module 839 preferably communicates information back to caching module 815 to facilitate optimization of disk block requests. Messages are generally received from traffic shaping module 836 and are passed to caching module 815. The preferred external interfaces of disk priority module 839 include traffic shaping module 836 and caching module 815.

Host processor subsystem 706 preferably includes the following functionality: initiates system boot and initialization sequence for content router 200; provides an external interface to serial port 318 for local and remote systems management; implements systems management functionality, including SNMP, Web based management interfaces, and serial port interface; handshakes with rapidstack subsystem 703 to collect data to support systems management; provides systems management platform APIs that can be exposed to implement a custom systems management presentation layer; accepts redirected file writes from rapidstack subsystem 703, implemented as a network attached storage (NAS) device supporting common internet file system (CIFS) and network file system (NFS) protocols; handshakes with rapidstack subsystem 703 to synchronize read/write access to local storage that flows through host processor 706; handshakes with rapidstack subsystem 703 to maintain a current file system directory; handshakes with rapidstack subsystem 703 to maintain cache coherency and implements clustering features such as failover from one content router 200 to another content router 200 in a cluster and auto-discovery and storage replication to each content router 200 added to such a cluster.

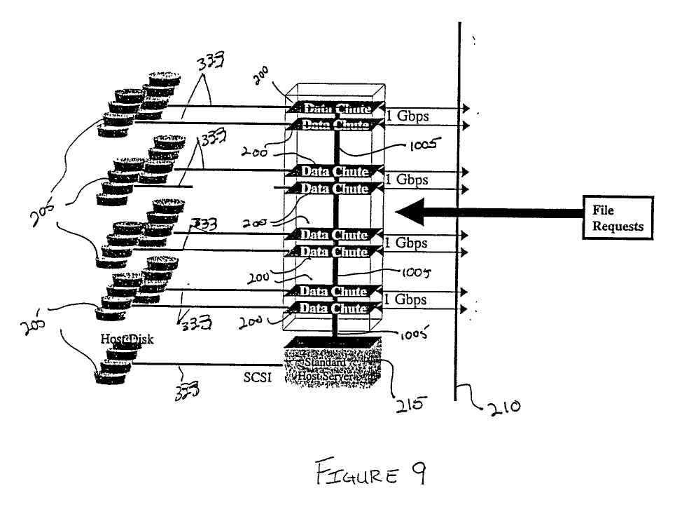

Referring now to FIG. 8, the preferred software modules included in host processor subsystem 706 are depicted according to one embodiment of the present invention. Accordingly, FIG. 8 identifies the following software modules for host processor subsystem 706: operating system 903; boot and initialization 906; inter-processor communication (IPC) 909; storage coherency 912; clustering 915; systems management platform APIs 918; and systems management presentation layer 921.

Operating system module 903 for host processor subsystem 706 is preferably a Unix derivative in one embodiment. Operating system module 903 preferably provides the components that are unshaded in FIG. 8, i.e., Telnet 924, extensible SNMP 927, HTTP 930, SSL (secure sockets layer) 931, NAS Protocols (CIFS and NFS) 933, TCP/UDP/IP/PPP/SLIP protocol stack 936 and storage file system 939. In addition, operating system module 903 preferably includes generic external interfaces with other modules in host processor subsystem 706.

Boot and initialization module 906 preferably runs in a boot ROM and may perform a variety of functions for the entire system. Examples of such functions include power on self test (POST), ROM Checksum, hardware initialization for the system, boot as well as the loading and execution of various software engines and subsystems. Boot and initialization component 906 primarily interfaces with hardware.

Inter-processor communication module 909 preferably provides an interface for modules within host processor subsystem 706 to communicate with modules in rapidstack subsystem 703. Pieces within inter-processor communication module 909 may include a thin Ethernet driver a thin disk driver as well as others. Host processor subsystem 706 preferably interfaces through rapidstack subsystem 703 to communicate over networks 327 and 210 for example. A thin Ethernet driver preferably provides the network interface required by the OS protocol stack on host processor subsystem 706, but passes through to thin Ethernet module 833 in rapidstack subsystem 703 to communicate on networks 327 and 210.

Host processor subsystem 706 preferably interfaces through rapidstack subsystem 703 to perform read/writes to storage 205. A thin disk driver preferably provides the interface required to the OS file system on host processor subsystem 706, but passes through to disk driver module 803 in rapidstack subsystem 703 to communicate with storage 205.

A rapidstack subsystem 703 handshake driver preferably includes a set of function calls that maps handshaking functions to the inter-processor communication 909 hardware implementation and preferably provides a variety of capabilities. Such capabilities may include: file locking prior to file writes; refresh of a rapidstack subsystem 703 copy of the file system directory; fetching a read request job table for fault tolerance; notifying rapidstack subsystem 703 to refresh its file cache; collecting logged statistics, counters, metrics, status, and alerts; as well as modifying configurations.

Inter-processor communication module 909 preferably maintains external interfaces and provides services to various host processor subsystem 706 modules. Such modules may include network protocol stack module 933, which preferably provides a network interface card driver interface; file system module 939, which preferably provides a disk driver interface; storage coherency module 912, which preferably provides an interface to handshake with rapidstack subsystem 703; systems management platform APIs module 918, which preferably provides an interface to read/write systems management data; clustering module 915, which preferably provides an interface to handshake with rapidstack subsystem 703. Inter-processor communication module 909 may also interface with hardware to implement handshaking with rapidstack subsystem 703.

Storage coherency (SC) module 912 preferably exists between NAS protocols module 933 and file system module 939. SC module 912 preferably presents itself as a file system to NAS protocol module 933. Whenever a request is received to open a file, SC module 912 intercepts that request and handshakes through inter-processor communication module 909 with rapidstack subsystem 703 to ensure that the file can be safely opened for read/write operation through NAS module 933. Once rapidstack subsystem 703 signals that the file can be opened, storage coherency module 912 allows NAS protocols module 933 to transparently interact with file system module 939 to perform file I/O.

After completion of a file write operation through NAS protocol module 933, SC module 912 preferably generates and forwards a new file system directory to rapidstack subsystem 703. SC module 912 may also notify rapidstack subsystem 703 to update its file cache after a file has been modified through NAS protocol module 933. Preferred external interfaces of storage coherency module 912 include NAS protocols module 933, which preferably provides a file system interface to NAS protocols module 933; file system module 939, which preferably allows file system module 939 requests to flow from NAS protocols module 933 to a real file system; inter-processor communication module 909, which preferably interfaces with the inter-processor communication module 842 to handshake with rapidstack subsystem 703 and to coordinate file I/O.

Clustering module 915 preferably handles functionality that spans content routers 200 and servers 215 in a cluster. Communications may be handled over a Gigabit Ethernet “Cluster LAN” port such a Gigabit Ethernet transceivers 440 and 445. Clustering module 915 is preferably operable to perform such functions as the detection of content routers 200 that drop off the cluster LAN, the initiation of failover functionality, and the discovery of content routers 200 that enter the cluster LAN and the initiation of procedures for the configuration and replication of storage data. Clustering module 915 preferably interfaces with inter-processor communication module 909 to perform such functions as sending heartbeat packets to other content routers 200 in a cluster and receiving discovery packets from other content routers 200 in the cluster. Clustering module 915 preferably interfaces with NAS Protocols module 933 to replicate files from one content router 200 storage subsystem to another content router 200 subsystem on the cluster LAN.

Systems management platform APIs module 918 preferably provides an interface to access all of the systems management functions available within content router 200. There may be multiple categories of APIs: configuration APIs; diagnostic APIs; fault management APIs; accounting APIs and alert registration APIs. Systems management platform APIs module 918 preferably interfaces with systems management external interface module 921 to provide access to get and set all systems management data to the components in the systems management external interface module 921 and with inter-processor communication module 909 to access systems management data in rapidstack subsystem 703.

Systems management presentation layer module 921 is generally concerned with the interpretation and presentation of systems management data. There are four preferred submodules in this layer. First, there is an SNMP submodule for each SNMP MIB (management information base) that may be supported. Second, URL handlers for WEB based management. URL handlers are a set of management URLs supported by content router 200 that may be linked to and from a standard WEB browser. The set of URL handlers may have multiple layers within itself. Third, a serial port user interface allowing local access to systems management functionality, such as a VT 100 style user interface that may be utilized locally, or over a Telnet dial-up network connection. Fourth, intelligent management submodules.

The architecture preferably supports the implementation of software submodules operable to focus on fault, configuration, and performance self-diagnosis and resolution as well as to send and receive systems management data to and from content routers 200 in a cluster. Systems management presentation layer module 921 preferably interfaces with SNMP submodules and intelligent management modules interface with SNMP submodules to register interest in certain MIBs as well as to send and receive SNMP requests. The URL handlers and intelligent management submodules interface with HTTP module 930 to receive HTTP read requests and to send HTML screen panels to facilitate WEB-based management of content router 200 over the Internet, or an Intranet. Serial port user interface 942 interacts with Telnet component 924 to allow management of a content router 200 through a local serially attached device or via a dial-up connection through a serial port. Generally all presentation layer components 921 interact with the systems management platform APIs module 918 to access systems management data in content router 200. Systems management enterprise platforms may include HP Openview, CA, UniCenter, Tivoli, BMC Patrol, CiscoWorks while storage management platforms such as Veritas, Legato, EMC and IBM as well as third party WEB based products such as Inktomi and Akamai may also be supported.

A plurality of different types of security are also preferably supported by content router 200. For example, authentication may be one type of security supported by content router 200 of the present invention. In an authentication scenario, the requesting client may be authenticated to verify it has the authority to access requested content. HTTP and FTP standard authentication may be used to effect such authentication based security.

Security from hacker/denial of service attacks may also be implemented in the security capabilities of content router 200. As such, content router 200 may be configured to report and defend against certain types of hacker and denial of service attacks.

Encrypted traffic received by content router 200 is preferably handled somewhere other content router 200. Accordingly, encrypted requests may be switched to a server 215 or other processing asset for handling.

Ease of deployment and ongoing manageability of content router 200 are key components of its functionality. Manageability may be broken down into the following areas: wire protocols; diagnostics; configuration; remote software/firmware updates; fault management; performance management; accounting; reporting; localization; intelligent manageability; enterprise management platforms; security; OEM platform requirements and future systems management standards.

The following wire management protocols are preferably supported by content router 200: SNMP; WEB Based Protocols (HTTP/HTML) and Serial Port Protocols (VT100/Telnet). SNMP is the defacto remote management protocol today. Supporting SNMP provides interoperability with multiple enterprise management platforms such as HP OpenView. In general, SNMP based management only provides the ability to view management data. Lack of security with SNMP means that content router 200 may not be modified in any way via SNMP.

Management over the Internet or over an Intranet from standard WEB browsers is preferred. WEB screen panels may be generated internal to content router 200 such that content router 200 may provide its own systems management graphical user interface (GUI). WEB based protocols preferably provide the capability to modify content router 200 remotely. Examples of such content router 200 modification include configuration and remote software/firmware updates.

Content router 200 may also be manageable through a serial port or similar connection. Local serial port access provides a user with a means to manage content router 200 when physically located alongside the product. Remote serial port access provides a “backdoor” path to manage a content router 200 in the case where the primary network path is down.

One management function included in the functionality of the present invention preferably includes diagnostics. As such, diagnostics are preferably capable of being run in either an offline or an online mode. To run diagnostics in online mode, content router 200 preferably remains in service without any perceived interruption in service. Diagnostics may also be capable running either locally through the serial port connection, or remotely using WEB based protocols.

Diagnostics may also be run “on demand” or tests may be scheduled to run at designated time intervals. Also, a selected set of system diagnostics may be replicated to run across selected multiple content routers 200.

Diagnostics software preferably breaks down into a variety of categories. Such categories may include low level diagnostic primitives and high level system diagnostics. Low level diagnostic primitives generally provide in depth access to the various components of content router 200. High level system diagnostics are preferably built upon low level primitives and generally provide cursory access to content router 200, such as those that may be employed by novice users.

Content router 200 may be remotely and locally configurable. A mechanism to minimally configure a content router 200 onto a network quickly and easily is preferably included. Once a content router 200 is up and running on the network, the remainder of the content router's 200 configuration may be performed.

There may be many methods for quickly configuring content router 200 onto a network. For example, a small network configuration profile staged on a web site that may be downloaded to a content router 200 based on the physical network address identification (MAC address) of content router 200 may be provided. Alternatively, a content router 200 may be configured at manufacture according to a site's specifications or, a user may set up a network configuration profile on their web site or on a Boot server which may be downloaded to content router 200 based on its MAC address. Once the content router 200 is up and on the network, it may be configured remotely. In addition, content router 200 preferably does not require a reboot when its configuration changes and the content router 200 is preferably capable of backing up to a previous configuration. A configuration may be replicated across multiple content routers 200 on the network or in a cluster to further implement ease of use.

Additional remote management functionality may be realized through remote software/firmware updates. When a content router 200 requires an update to a newer version of software or firmware, it is preferably provided as an entire image. Such software and firmware updates may be staged on a Web site. Such an approach greatly optimizes the test and support matrix for multiple releases of various components within an implementation.

New release images may be “pulled” by systems management software running on content router 200. This “pull” of the latest software or firmware image can be triggered by customer requests for a remote upgrade through the systems management GUI or by intelligent, self monitoring systems management software running on content router 200. Systems management software is preferably capable of detecting a new release on a provided Web site and further capable of automatically initiating a remote upgrade to the latest image. As mentioned above, the ability to “backup” to a previous installation, should problems result from an update, is preferably provided for in content router 200.

Content router 200 of the present invention is preferably configured to perform various fault management functions. According to teachings of the present invention, fault management may include monitoring, alerting and problem resolution.

With respect to monitoring, content router 200 is preferably operable to monitor the health of key hardware and software subsystems. For each subsystem, a set of subsystem counters and statistics may be monitored and logged. The counters and statistics may then be interpreted into meaningful status information by the GUI layer of the systems management software and subsequently made available to a user for interpretation.

Predefined events occurring within each subsystem may generate systems management alerts. Such system management alerting may be performed and monitored using custom thresholds. As such, for certain counters and statistics, a user may be able to customize various thresholds in order to generate custom alerts.

Systems management intelligent software modules are preferably operable to monitor health statistics and alerts as well as to initiate self diagnosis of the system such that automatic problem resolution recommendations or self corrective actions may be effected. Access to low level counters and statistics may be provided via a systems management GUI. Detection of pre-failure conditions in various hardware subsystems is preferably included and alerts may be generated based upon detection of such conditions.

Performance management is similar to fault management, however, performance management focuses on how well content router 200 is performing, rather than whether the health of content router 200 may be degraded. Performance management may also be tied to capacity planning. The system management tools that analyze collected performance data may also be capable of recommending additional capacity when appropriate. Beyond this, a user may enable systems management software to submit an order for additional equipment as well as to notify the user that an order has been placed. Performance management may also be capable of analyzing and recommending performance improvements for a cluster of content routers 200.

Accounting for traffic patterns and other content router 200 uses may also be included in the present invention. As such, there may be a desire to record billing information. This information may be fed into existing third party billing applications or utilized for other purposes.

Similarly, reporting functionality may be incorporated into the content router's 200 functionality. Reporting generally involves storing snapshots of information collected over a period of time into a history database.

Various levels of intelligent manageability may also be incorporated into the functionality of content router 200 of the present invention. Such “Intelligent” software modules are preferably capable of self-monitoring, self-diagnosis, generation of problem resolution recommendations, and self-correcting actions. These intelligent software modules may be provided in the areas of fault management and performance management. For example, the ability to predict an impending failure of a subsystem within content router 200 as well as the ability to notify the customer that maintenance should be scheduled may be one fault management implementation. Further, if authorized to do so through configuration, the intelligent software module may order replacement parts and notify the customer when they are to arrive so that maintenance may be scheduled.

An additional example may include the ability to identify performance bottlenecks within content router 200 and to notify the customer of any action that should be taken. Actions may include changing a performance configuration parameter, or deploying additional content routers 200. If authorized to do so through configuration, the intelligent module may modify a performance configuration parameter or order additional product, and notify the customer of any automatic action taken.

Security is generally required for any Systems Management function that modifies or sets any parameter on the content router. Modification examples may include reconfiguration and software/firmware updates.

One way to implement security may involve the use of Web based protocols to facilitate remotely modifying the functionality of the content router 200. In this environment, SSL may be preferred to provide an acceptable level of security.

New systems management standards are evolving everyday. The systems management software design is preferably extensible to support such new standards as they are adopted and as users begin to desire support for them. Examples of such new standards include CIM/WBEM (common information model/web-based enterprise management), policy based management standards and directory services. Content router 200 is preferably interoperable with third party Web based hardware and software made by such companies as Veritas, Inktomi and Akamai.

As illustrated in FIG. 9, a Gigabit Ethernet backchannel or LAN 1005, with other interfaces, including those with higher bandwidth capability possible, is used to interconnect multiple content routers 200 together in a cluster as well as to a server 215 host. As mentioned above, content router 200 clusters are preferably configured to auto-discover new content routers 200 which have been added to the cluster. Each added content router 200 is preferably automatically configured with at least the parameters and storage 205 content of the content router 200 with the hottest demand history.

Content router 200 manager software preferably runs coherently on all content routers 200 in a cluster and may be configured to dynamically balance demand loading. The content router 200 manager software may also be configured to auto-detect hot-spot content demand and to dynamically provision bandwidth allocation to maintain peak performance levels. Hot-spot content is generally defined as content which has above average access requests when compared to other content accessible by the content router 200 cluster.

Content router 200 may also function as part of a Web Hosting cluster. In one embodiment, two or more content routers 200 may be clustered together to provide increased capacity and throughput as well as to provide fault tolerant features. One or more servers 215 may also exist on the cluster. In part to increase the delivery of content, content router 200 of the present invention may directly access storage 205, via SAN 333 for example, to serve static content.

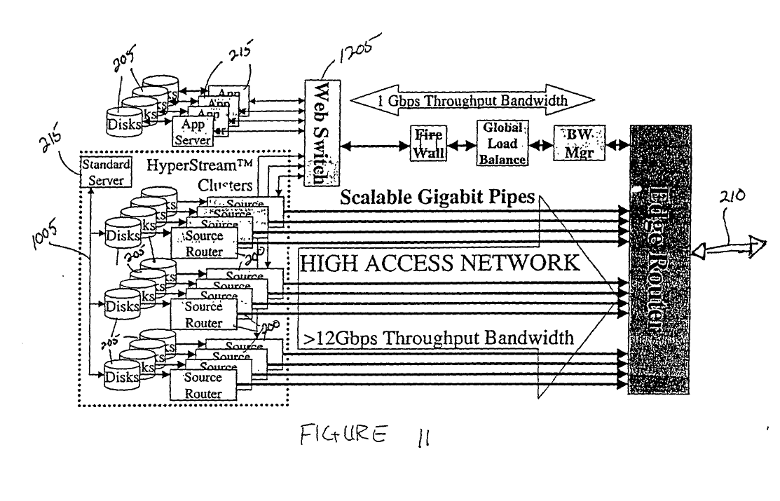

Referring now to FIG. 10, further embodiments of how a content router 200 may be employed in a system and how a content router 200 may interact with other components on a network is depicted. As such, there are preferably four external interfaces on content router 200. The four preferred external interfaces include a load balancing switch interface 1103, a cluster LAN interface 1106, a storage area network/SCSI interface 1109 and a serial port interface 1112.

With respect to the load balancing switch interface 1103, content router 200 preferably includes a Gigabit Ethernet connection, such as Gigabit Ethernet transceiver 440 or 445, to load balancing switch 1115. Load balancing switch 1115 preferably provides connectivity to at least WAN 210. In such an implementation, load balancing switch 1115 preferably handles the load balancing of inbound packets across multiple content routers 200. Each content router 200 in a cluster generally sends TCP/IP connection setup and HTTP/FTP read response packets to load balancing switch 1115 on an outbound path.

With respect to the cluster LAN interface 1106, such as Gigabit Ethernet transceiver 440 or 445, content router 200 preferably includes an interface to what may be termed a cluster LAN 1005. Cluster LAN 1005 preferably runs Gigabit Ethernet for communication. Content router 200 preferably uses this connectivity to communicate with one or more servers 215, as well as with additional content routers 200 in a cluster.

With respect to content router 200 to server 215 connectivity in particular, content router 200 preferably switches certain traffic between itself and server 215. Examples of such traffic may include HTTP read requests for dynamic data that are preferably switched to server 215, HTTP read responses from server 215 that are preferably switched through content router 200 from cluster LAN 1005 to WAN 210 through load balancing switch 1115 as well as writes from server 215 to storage 205 that are preferably switched through content router 200 from cluster LAN 1005 to storage area network 333 to storage devices 205.

With respect to content router 200 to content router 200 connectivity in particular, control functions and systems management data preferably flow between the content routers 200 on cluster LAN 1005 in order for the content routers 200 to operate as a cluster. Examples of such data may include heart beat packets facilitating failover from one content router 200 to another, the gathering of performance data by a primary content router 200 from other content routers 200 in the cluster as well as other data.

With respect to storage area network/SCSI interface 1109, content router 200 is preferably connected to local storage 205 either through a Fibre Channel connection, such as Fiber Channel transceiver 450, or through a SCSI Bus interface. Both read and write traffic preferably flows on SAN/SCSI interface 1109.

With respect to serial port interface 1112, content router 200 preferably maintains a serial port connection to facilitate both local and remote access to content router 200. Serial port interface 1112 may be used remotely to connect via Telnet, for example, as a backdoor path when the network is unavailable. A locally attached console preferably provides local access to manage content router 200 via serial port interface 1112.

A variety of deployment scenarios are contemplated by the teachings of the present invention. As such, content router 200 of the present invention preferably functions such that it may “drop” into any of the deployment scenarios described as well as into other scenarios.

The scenarios defined in this section vary based on the type of switch that a content router 200 cluster may be connected to. In the case of load balancing Web switch 1115 mentioned above, content router 200 may not be required to handle the switching of TCP/IP connection requests and application protocol packets to server 215. The switching of TCP/IP connection requests and application protocol packets may be handled by load balancing switch 1115 in such an implementation.

In the case of a load balancing layer 4 switch replacing load balancing web switch 1115, generally all traffic is switched by the load balancing layer 4 switch to content routers 200. Therefore, content router 200 preferably handles the switching of TCP/IP connection requests and application protocol packets to server 215. Further, the load balancing layer 4 switch generally handles load balancing across the multiple IP addresses presented by the content router 200 cluster.

In the case of a layer 3 or layer 2 switch replacing load balancing web switch 1115, content router 200 preferably handles all load balancing and switching to nodes within the content router 200 cluster, including that traffic which needs to be switched to server 215. In this scenario, there may be a primary content router 200 in the cluster that is operable to load balance TCP/IP connection setups and application layer protocols across the remaining content routers 200 and servers 215 in the cluster.

Accordingly, content router 200 of the present invention preferably includes extensive third party product interoperability. Examples of such third party interoperability may include switches, Web switches, load balancing switches, non-load balancing switches, Web hosting platforms, general purpose file server platforms, operating system platforms, applications, third party storage products, fibre channel switches, fibre channel RAID storage systems and switched vs. arbitrated loop support.

As illustrated in FIG. 11, content router 200 is generally unencumbered by the general computing and file management complexities of a standard computer, and is generally limited in performance only by setup/tear down latency for a request, speed of storage 205 to deliver content, and aggregation speed. The architecture of content router 200 generally moves the throughput bottleneck back to storage 205. A novelty of the accelerated data path or cluster LAN 1005 is that it controls both the ingress and egress data streams. As such, it implements a source router function in a high access network. While this device has been described as uni-directional access only, it may be augmented to receive content from other sources and to transfer it through a backchannel or other interface into a computer memory for subsequent processing.

With a general understanding of the hardware and software components of content router 200 complete, it is possible to discuss preferred high-level functionality that may be incorporated into content router 200. Such high-level functionality may be broken down as follows: Web site configurations; supported protocols; TCP/IP; HTTP read requests; file transfer protocol (FTP); storage subsystems; content management; load balancing; fault tolerance; traffic shaping; physical interfaces; performance/capacity/scalability; security; and systems management. With respect to Web site configurations, content router 200 is preferably operable to “plug in” to an identified set of configurations with as low of an impact as possible. With respect to supported protocols, the content router preferably processes TCP connection requests, HTTP read requests for static content, and FTP Gets.

Regarding TCP/IP, content router 200 preferably manages the setup of generally all incoming TCP/IP connection requests for a Web site. By taking over this function, content router 200 essentially offloads TCP/IP connection setup from any associated server or servers 215. Once a TCP/IP connection has been established, content router 200 may process HTTP read requests for static content and FTP Gets. All other protocols are preferably switched to server 215 for processing. In addition, content router 200 preferably maintains a single, generally constant, TCP/IP connection to server 215. All protocols that are switched to server 215 are preferably mapped onto this single TCP/IP connection. TCP/IP connections are also preferably maintained to provide connectivity to additional content routers 200 configured in a cluster. This TCP/IP connection generally enables content routers 200 to provide failover protection, load balancing, and other cluster related functionality.

HTTP read requests that are preferably processed by content router 200 may be generally divided into two categories, static content HTTP read requests and dynamic content HTTP read requests. Static content may be defined as content available to content router 200 via attached storage 205 and as content that does not generally require any processing. In other words, static content may be streamed “as is” directly from attached storage 205. It is estimated that 70% of HTTP read requests are typically for static content. Accordingly, content router 200 preferably offloads 100% of the processing of HTTP read request for static content from server 215. As such, static content may be streamed from local storage 205 to network 210 by content router 200. Generally all file read requests are stored in a read queue. Based on CoS/QoS policy parameters as well as buffer status within the file reader (empty, full, near empty, block seq#, etc.), the file reader may prioritize which blocks of which files to access from storage 205 next, and subsequently transfer this content into a buffer memory location that has been assigned to be transmitted to a specific IP address.

Dynamic content, on the other hand, may be defined as content that either requires processing, or resides remotely from server 215 cluster and/or content router 200 cluster. HTTP read requests for dynamic content are preferably switched to server 215 by overlaying read requests and read responses onto a single, permanent TCP/IP connection between server 215 and content router 200.

File transfer protocol (FTP) processing may also be broken into two separate categories, FTP Gets and FTP Puts. Content router 200 preferably handles the processing of all FTP Gets, request for files from storage 205. FTP Puts, requests to write content to storage 205, are preferably switched to server 215 for processing.

Content router 200 may also include data management related functionality. While server 215 is preferably responsible for updating content in storage 205, content router 200 may be operable to solve the problem of synchronizing access to the content in storage 205 such that current content may be delivered.

For implementations involving a plurality of content routers 200 configured in a cluster, the ability to perform load balancing is preferably included in content router 200. As such, content router 200 preferably has the ability to be clustered with additional content routers 200, such as in a single Web site configuration, generally to increase bandwidth with respect to storage 205 access. Alternatively, a load balancing switch 1115, or a Web switch 1205, may be incorporated into the cluster to provide load balancing for incoming TCP/IP connection requests across multiple content routers 200 configured in a cluster.

In implementations where the capabilities of load balancing switch 1115 are not employed, a primary content router 200 may be oriented such that it will initially receive incoming requests and load balance those requests across multiple content routers 200 arranged as a load balancing team. There may be multiple algorithms for effectively achieving such load balancing. For example, the primary content router 200 may be operable to tell its internal switching unit to redirect a connection request to a different switch port, thereby enabling the load balancing of one or more TCP/IP connections across multiple content routers 200. In a further example, the primary content router 200 may switch a connection request to another content router 200 in the cluster where the secondary content router 200 preferably completes the TCP/IP connection setup through one of its available switch ports. In yet another example, the primary content router 200 may set up the TCP/IP connection and load balance any application layer protocol processing across multiple content routers 200. In effect, this will preferably result in all traffic flowing through the primary content router 200.

To provide reliable service, content router 200 is preferably operable to provide high levels of fault tolerance. Content routers 200 existing within a cluster preferably include the ability to provide fault tolerance through failover from a primary content router 200 to at least a secondary content router 200. As such, the minimum fault tolerance functionality preferred is the ability to failover from a primary content router to a redundant “hot spare” content router 200. Client systems coupled to a primary content router 200 that fails may experience loss of connection. However, the clients are generally capable of re-coupling quickly.

Two or more content routers 200 may be configured as a fault tolerant “team”. Non-primary content routers 200 in such a team preferably trade heartbeats with the primary content router 200. When a non-primary content router detects the failure of the primary content router 200, the non-primary content router 200 preferably assumes the IP and MAC (media access control) addresses of the primary content router 200.

Once a failover has occurred, there may be multiple algorithms with which the return to service of the original primary content router 200 may be handled. For example, when the original primary content router 200 returns to service, it may assume the role of a non-primary content router 200 member of the team. Alternatively, when the original primary content router 200 returns to service, it may reassume the role of primary content router 200 and the current primary content router 200 may then return to the role of non-primary content router 200.

Further functionality preferably included in content router 200 includes the ability to perform traffic shaping. Content router 200 preferably shapes outgoing traffic based on configurations set up by a user. A traffic cop is preferably included which manages traffic within content router 200. Traffic queues are preferably used to ensure optimal traffic shaping throughout content router 200.

Although the present invention has been described with respect to a specific preferred embodiment thereof, various changes and modifications may be suggested to one skilled in the art. It is intended that the present invention encompass such changes and that such modifications fall within the scope of the appended claims.

What is claimed is:

1. A system for delivering content throughout a network, the system comprising:
a content transport component operably coupled to the network;
a storage management component;
at least one accelerated data path operably coupling the content transport component and the storage management component; and
the content transport component operable to process requests for static content received from the network and to switch requests for dynamic content received from the network to the storage management component.

2. The system of claim 1 further comprising:
at least one storage device; and
at least one server operably coupled to the storage device.

3. The system of claim 1 further comprising at least one content router operably coupled to the network and the storage management component.

4. The system of claim further comprising the accelerated data path operable to deliver content available from the storage management component to at least one client operably coupled to the network.

5. The system of claim 1 further comprising:
a first accelerated data path operably coupled to the content transport component and operable to deliver content from a storage device operably coupled thereto; and
a second accelerated data path operably coupled to the content transport component and operable to deliver requests for dynamic content to a server operably coupled thereto.

6. A system for delivering content from a storage device comprising:
at least one storage device;
at least one content router operably coupled to the storage device;
the content router including at least one network processor;
a memory operably coupled to the at least one network processor;
at least one routing switch operably coupled to the network processor;
a LAN interface operably coupled to the routing switch and operable to communicate with a local area network;
a WAN interface operably coupled to the routing switch and operable to communicate packets of content with a wide area network;
a SAN interface operably coupled to the routing switch and operable to communicate with the storage device via a storage area network; and
a program of instructions storable in the memory and executable in the processor operable to interrogate the packets received through the WAN interface and to instruct the routing switch to switch the packets between the LAN, WAN and SAN interfaces based upon the results of the interrogation.

7. The system of claim 6 further comprising at least one server operably coupled to the LAN interface.

8. The system of claim 6 further comprising:
the program of instructions operable to process interrogated packets containing a request for static content; and
the program of instructions further operable to instruct the routing switch to maintain an accelerated data path between the SAN interface and the WAN interface such that the static content may be delivered from the at least one storage device to one or more clients operably coupled to the WAN interface.

9. The system of claim 6 further comprising the LAN interface operable to establish and maintain a generally constant communication connection with at least one server.

10. The system of claim 6 further comprising the program of instructions operable to instruct the routing switch to switch unsupported traffic received through the WAN interface to at least one server.

11. The system of claim 6 further comprising at least one load balancing switch operably coupled to the WAN interface.

12. The system of claim 6 further comprising:
a serial interface operably coupled to the network processor; and
the serial interface operable to couple to a computing device and to transmit control signals from the device to the network processor such that the content router may be controlled by the device.

13. The system of claim 6 further comprising the content router operable to provide read-only access to the at least one storage device via the SAN interface.

14. The system of claim 6 further comprising the program of instructions operable to configure one or more content routers operably coupled to the LAN interface with at least hot-spot content available on the at least one storage device.

15. The system of claim 6 further comprising the program of instructions operable to provide failover services to one or more content routers operably coupled in a cluster.

16. The system of claim 6 further comprising the content router operable to maintain at least one communication connection with one or more clients operably coupled to the WAN interface.

17. A content router comprising:
a packet switching component;
a first network component operably coupled to the packet switching component;
a storage component operably coupled to the packet switching component; and
the packet switching component, the first network component and the storage component cooperating with each other to create an accelerated data path operable to deliver static content from at least one storage device operably coupled to the storage component to at least one client operably coupled to the first network component.

18. The content router of claim 17 further comprising:
a second network component operably coupled to the packet switching component; and
the second network component and the packet switching component cooperating with each other to switch unsupported network traffic received via the first network component to one or more servers operably coupled thereto.

19. The content router of claim 17 further comprising the packet switching component operable to interrogate traffic received through the first network component and to make a switching decision based upon results of the interrogation.

20. The content router of claim 17 further comprising:
a systems management component operably coupled to the packet switching component; and
the systems management component operable to perform one or more content router management functions.

21. The content router of claim 20 further comprising the systems management component operable to configure one or more content routers operably coupled thereto.

22. The content router of claim 17 further comprising the packet switching component operable to process file transfer protocol gets and to switch file transfer protocol puts received from one or more clients operably coupled to the first network component to at least one server.

23. The content router of claim 17 further comprising:
a second network component operably coupled to the packet switching component; and
the second network component operable to couple to one or more content routers such that a content router cluster may be formed.

24. The content router of claim 17 further comprising the first network component operable to set up and tear down one or more communication connections with one or more clients operably coupled thereto.

25. The content router of claim 17 further comprising:
at least one communications port operable coupled to the packet switching component; and
the communications port operable to allow a device coupled thereto to control one or more functions of the content router.

26. The content router of claim 17 further comprising the accelerated data path operable to allow read-only access to the content available from the at least one storage device operably coupled to the storage component.

27. A content router comprising:
at least one power supply;
a motherboard operably coupled to the power supply including at least one processor and memory operably coupled to the processor;
a printed circuit board operably coupled to the motherboard;
the printed circuit board including at least one network processor, memory operably coupled to the at least one network processor, a routing switch operably coupled to the network processor, a storage area network transceiver operably coupled to the routing switch and a first network transceiver operably coupled to the routing switch; and
the printed circuit board operable to read packet headers received from one or more clients operably coupled to the first network transceiver and to process those packets containing requests for content accessible via the storage area network transceiver.

28. The content router of claim 27 further comprising the printed circuit board operable to switch those packets not processed to one or more servers operably coupled thereto.

29. The content router of claim 27 wherein the printed circuit board further includes:
a second network transceiver; and
the second network transceiver operable to couple to one or more content routers such that a content router cluster may be formed.

30. The content router of claim 27 further comprising the printed circuit board operable to configure one or more content routers operably coupled thereto.

31. The content router of claim 27 wherein the circuit board further includes:
an accelerated data path; and
the accelerated data path operable to provide access to content available from one or more storage devices operably coupled to the storage area network transceiver to one or more clients operably coupled to the first network transceiver.

32. The content router of claim 27 further comprising the printed circuit board operable to set up and to tear down TCP/IP connections with one or more clients operably coupled to the first network interface.

33. The content router of claim 27 further comprising the printed circuit board operable to maintain a generally constant TCP/IP connection with one or more servers operably coupled thereto.

34. The content router of claim 27 further comprising:
the printed circuit board operable to detect one or more content routers operably coupled thereto; and
to configure the one or more content routers with at least hot-spot content available from one or more storage devices operably coupled thereto.

35. The content router of claim 27 further comprising the printed circuit board operable to provide read-only access to one or more storage devices operably coupled to the storage area network transceiver such that one or more clients operably coupled to the first network interface may not alter content contained thereon.

36. A system for delivering content throughout a world wide computer network comprising:
at least one server operably coupled to a local area network;
at least one storage device operably coupled to a storage area network;
at least one network appliance operably coupled to the local area network, the storage area network and a wide area network; and
the network appliance operable to interrogate network traffic received from the wide area network, to process any network traffic requesting static content available from the storage device and to switch any network traffic not processed by the network appliance to the server via the local area network for validation.

37. The system of claim 36 further comprising:
the network appliance operable to receive validated network traffic from the server; and
the network appliance further operable to process the validated network traffic received from the server.

38. The system of claim 36 further comprising the network appliance operable to receive and interrogate all network traffic at a site.

39. The system of claim 36 further comprising:
a plurality of network appliances operably coupled to the local area network, the storage area network and the wide area network; and
at least one of the plurality of network appliances operable to load balance network traffic received via the wide area network among the remaining network appliances.

40. The system of claim 36 further comprising the network appliance operable to configure one or more network appliances operably coupled to the local area network with at least hot-spot content available from the storage device.

41. The system of claim 36 further comprising the network appliance operable to provide failover services to one or more network appliances operably coupled to the local area network.

42. The system of claim 36 further comprising the network appliance operable to:
access content requested by the network traffic stored on the storage device via the storage area network; and
deliver to one or more addresses on the wide area network the content requested by the network traffic and stored on the storage device.

43. The system of claim 36 further comprising the network appliance operable to deliver all content requested by the network traffic received at a site.

44. The system of claim 36 further comprising the network appliance operable to provide one or more clients operably coupled to the wide area network read-only access to content available from the storage device.
